(19) United States
(12) Patent Application Publication
(10) Pub. No.: US 2021/0171326 A1
(43) Pub. Date: Jun. 10, 2021

(54) Multi-Lifting Plate Jack

(71) Applicant: PANEL JACKS, Bloomington, CA (US)

(72) Inventor: Terry Lee Call, Bloomington, CA (US)

(21) Appl. No.: 16/898,373

(22) Filed: Jun. 10, 2020

Related U.S. Application Data
(60) Provisional application No. 62/945,784, filed on Dec. 9, 2019.

(51) Int. Cl. B66F 3/46; B66F 3/25

(52) U.S. Cl. CPC B66F 3/46; B66F 3/25

(57) ABSTRACT

A lifting device includes two lifting plates, four rams coupled to the two lifting plates, and a pump coupled to the four rams. Two of the four rams are coupled at two sides of one of the two lifting plates and are configured to move the one lifting plate along a first direction when operated by the pump. The other two of the four rams are coupled at two sides of another one of the two lifting plates and are configured to move the other lifting plate along a second direction when operated by the pump.

### CROSS-REFERENCE TO RELATED APPLICATION

This application claims priority to and the benefit of U.S. Provisional Application Ser. No. 62/945,784, filed on Dec. 9, 2019, the entire content of which is hereby incorporated by reference.

### BACKGROUND

### 1. Field

The present disclosure relates to a device to lift or move objects.

### 2. Description of the Related Art

There is a need to safely and efficiently lift or move increasingly heavy objects, such as wall panels during the construction of a building or structure.

### SUMMARY

According to an embodiment of the present disclosure, a lifting device includes two lifting plates, four rams coupled to the two lifting plates, and a pump coupled to the four rams. Two of the four rams are coupled at two sides of one of the two lifting plates and are configured to move the one lifting plate along a first direction when operated by the pump. The other two of the four rams are coupled at two sides of another one of the two lifting plates and are configured to move the other lifting plate along a second direction when operated by the pump.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic, view of an assembled lifting device, according to an embodiment of the present disclosure.

FIG. 2 is a side view of each of six sides of a manifold, according to an embodiment of the present disclosure.

FIG. 3 is a side view of a ram, according to an embodiment of the present disclosure.

FIG. 4A is a side view of a collar, according to an embodiment of the present disclosure.

FIG. 4B is bottom view of the collar of FIG. 4A.

FIG. 5 is a plan view of a lifting plate, according to an embodiment of the present disclosure.

FIG. 6 is a perspective view of an assembled lifting device in a turned-off state, according to an embodiment of the present disclosure.

FIG. 7 is a perspective view of the assembled lifting device of FIG. 6 in a turned-on state, according to an embodiment of the present disclosure.

### DETAILED DESCRIPTION

According to some embodiments, a lifting device includes two lifting plates, which may be laid flat on the ground. An object to be lifted is placed on top of the two lifting plates. Each of the two lifting plates has two hydraulic jacks attached at opposite sides of the lifting plate so that, when the hydraulic jacks are operated, a piston of each hydraulic jack extends downward. All four hydraulic jacks are connected to a single pump to be operated substantially simultaneously. Therefore, when the pump is activated, the pistons of the hydraulic jacks extend downward, causing the two lifting plates to be pushed upward off the ground. Accordingly, the lifting device may be used to lift the object off the ground.

Example embodiments will be described in more detail with reference to the accompanying drawings, in which like reference numbers refer to like elements throughout. The subject matter of the present disclosure, however, may be embodied in various different forms, and should not be construed as being limited to the embodiments disclosed herein. For example, spatially relative terms, such as “upward,” “downward,” “under,” “over,” and the like, may be used herein for ease of explanation to describe the operation of the device or to describe the spatial relationship between components of the device, but embodiments of the present disclosure are not limited by the use of these spatially relative terms.

As disclosed herein, when one component is described as being “coupled” to another component, the one component may be, for example, connected, attached, or fixed to the other component, but the present disclosure is not limited thereto. Furthermore, the one component may be directly coupled to the other component, or the one component may be indirectly coupled to the other component, for example, through intervening components.

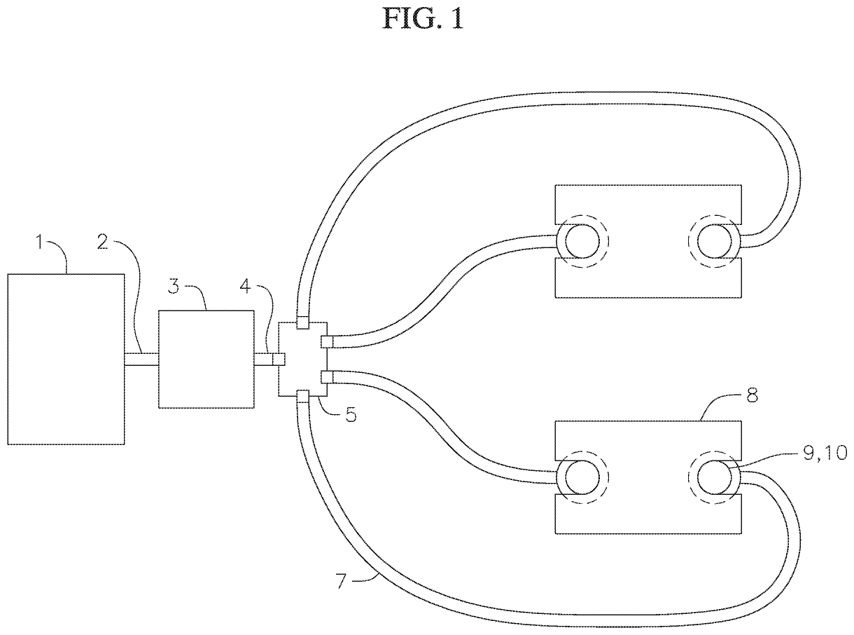

With reference to FIG. 1, the lifting device may include an oil reservoir 1, oil, an oil pump 3, a manifold 5, four hoses 7, two lifting plates 8, four rams 9, and four collars 10. When the apparatus is assembled, the oil reservoir 1 may be coupled to the oil pump 3; the manifold 5 may be coupled to the oil pump 3; one end of each of the four hoses 7 may be coupled to the manifold 5; the other end of each of the four hoses 7 may be coupled to a corresponding one of the four rams 9; each of the four collars 10 may be coupled to the four rams 9; and the collar 10 of each of the four rams 9 may be fitted into slots in the lifting plates 8. When the apparatus is so assembled, the oil pump 3 may transfer oil between the oil reservoir 1 and each of the four rams 9. For example, the oil pump 3 may transfer oil to each of the four rams concurrently or substantially simultaneously. The oil pump 3 may transfer oil substantially uniformly to the four rams. When oil is transferred into the four rams 9, a moveable piece 9B in each of the four rams 9 may extend or be forced downward, causing the lifting plates 8 (and an object situated on the lifting plates 8) to be pushed upward. The moveable piece 9B may be a piston.

The oil reservoir 1 and the oil pump 3 may be coupled together by a first coupling device 2, which allows for the transfer of oil between the oil reservoir 1 and the oil pump 3, as illustrated in FIG. 1. For example, the first coupling device 2 may be a hose, a pipe, or any other suitable coupling device. However, in some embodiments, the oil reservoir 1 and oil pump 3 may be integrated together into a single device, and the first coupling device 2 may be omitted.

The oil reservoir 1 may have any suitable volume for containing the oil used in the device. The volume of the oil reservoir 1 may be approximately the same as, or greater than, the volume of the oil used in the apparatus. In some embodiments, the oil reservoir 1 may be within the range of about 0.1 gallons to about 10 gallons. In some embodiments, the oil reservoir 1 may be within the range of about 1 gallon to about 3 gallons. In some embodiments, the oil reservoir 1 may be about 2 gallons.

The oil may be any suitable kind of oil for operating the apparatus. In some embodiments, the type of oil may be a lightweight oil. In some embodiments, the type of oil may be number 46 hydraulic oil. In some embodiments, the hydraulic fluid may be a fluid other than oil.

The oil pump 3 may be any pump suitable for operating the apparatus. In some embodiments, the oil pump 3 may be a hydraulic pump. The oil pump 3 may apply any suitable pressure per unit area to operate the device, such as a pressure per unit area within the range of about 12,000 PSI to about 12,500 PSI.

The manifold 5 and the oil pump 3 may be coupled together by a second coupling device 4, which allows for the transfer of oil between the oil pump 3 and the manifold 5, as illustrated in FIG. 1. For example, the second coupling device 4 may be a hose, a pipe, or any other suitable coupling device. However, in some embodiments, the oil pump 3 and the manifold 5 may be integrated together into a single device, and the second coupling device 4 may be omitted.

The manifold may include five ports, including 1 input port 6A to allow transfer of oil between the manifold 5 and the oil pump 3, and four output ports 6B to allow transfer of oil between the manifold 5 and each of the four rams 9, via (e.g., through) the four hoses 7.

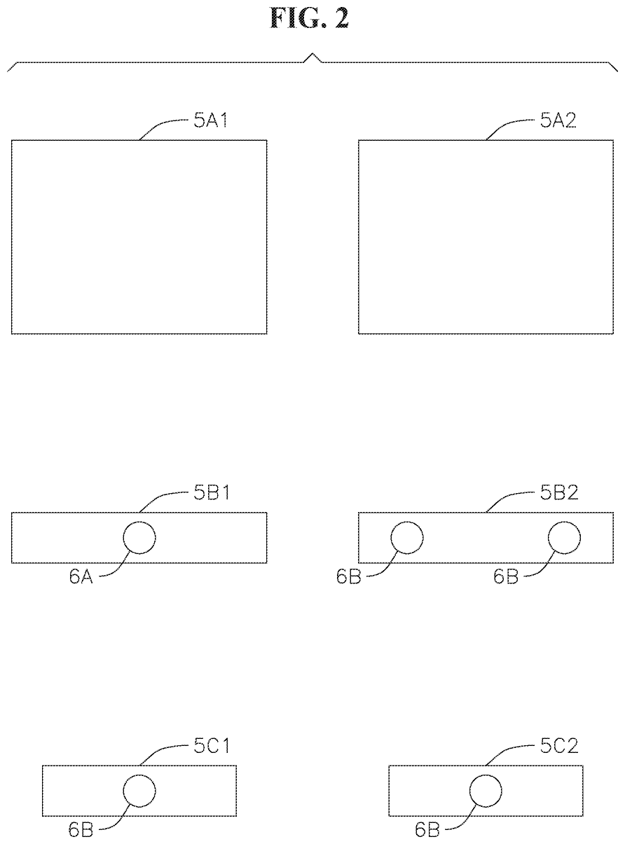

The manifold 5 may be of any suitable shape. With reference to FIG. 2, the manifold 5 may be a rectangular block having three pairs of opposite sides (5A1, 5A2, 5B1, 5B2, 5C1, and 5C2). In some embodiments, the input port 6A may be alone on one side (e.g., side 5B1), two of the output ports 6B may be on the opposite side as the side having the input port 6A (e.g., side 5B2), and the remaining two output ports 6B may each be alone on one of two opposite sides (e.g., one output port 6B may be on side 5C1 and the other output port 6B may be on side 5C2). However, in some embodiments, the input port 6A may be on side 5B1 and the four output ports 6B may each be alone on one of the five other sides (e.g., each of the four output ports 6B may be alone on one of the following four sides: 5A1, 5A2, 5C1, and 5C2).

The manifold 5 may include one or more cavity channels connecting the input port 6A to each of the four output ports 6B. For example, a first cavity may provide a channel between the two output ports 6B located on sides 5C1 and 5C2; a second cavity may provide a channel between the input port 6A on side 5B1 and the first channel; and a third and fourth cavity may each provide a channel between a corresponding one of the two output ports 6B on side 5B2 and the first channel.

The manifold 5 may be any suitable material. In some embodiments, the manifold 5 may include one or more metals or metal alloys. In some embodiments, the manifold 5 may include steel. For example, the manifold 5 may include hot or cold plate, mild steel, number A36.

One end of each of the four hoses 7 may be coupled to the manifold 5 by fittings. For example, each fitting may be coupled to an output port 6B of the manifold 5 and may be coupled to one end of one of the four hoses 7. The fittings may be any suitable kind of fitting. In some embodiments, the fittings may be brass fittings. In some embodiments, the fittings may include a shut-off switch that allows the flow of oil through the fitting to be controlled. For example, the shut-off switch may allow the flow of oil to be started, reduced, or stopped.

In some embodiments, fittings may be used elsewhere in the apparatus. For example, in some embodiments, fittings may be used at one or more of the four rams 9 (e.g., to couple the other end of the hoses 7 to corresponding rams 9), at the input port 6A of the manifold 5, at one or both ends of the first coupling device 2, and/or at one or both ends of the second coupling device 4.

The four hoses 7 may be any suitable kind of hose. The hoses 7 may be whip wire hoses that prevent the hose 7 from whipping around if it becomes separated from the manifold 5 or fitting when the hose 7 is under pressure.

In some embodiments, all four hoses 7 may have an equal or substantially equal length. In other embodiments, one or more of the four hoses 7 may have a different length than the other hoses 7. For example, two of the four hoses 7 may have a first length, and the other two hoses 7 may have a second length.

The length of the four hoses 7 may be any suitable length. In some embodiments, one or more of the hoses 7 may have a length of at least 6 feet. In other embodiments, one or more of the hoses 7 may have a length of at least 10 feet.

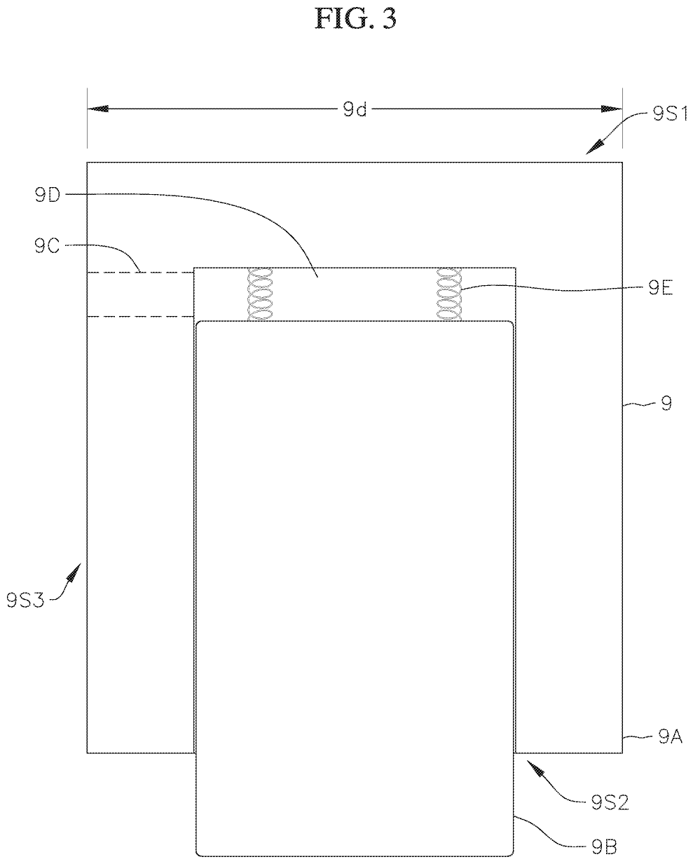

The four rams 9 may be any suitable ram jack, such as a hydraulic ram jack. With reference to FIG. 3, the rams 9 may include an outer case 9A configured to hold (e.g., contain, house, etc.) a moveable piece 9B. The outer case 9A and the moveable piece 9B may each have any suitable shape, and, in some embodiments, they may both have an approximately cylindrical shape. When the outer case 9A is approximately cylindrical, it may have a first flat side 9S1, a second flat side 9S2 opposite to the first flat side 9S1, and a curved side 9S3. The outer case 9A may have an opening at the second flat side 9S2 to allow the moveable piece 9B to move in and out of the outer case 9A through the opening.

The rams 9 may further include an oil channel 9C configured to allow the transfer of oil between a corresponding one of the hoses 7 and a cavity 9D in the ram 9. When oil is transferred into the cavity 9D, an outward force may be applied to the moveable piece 9B, pushing it out of the outer case 9A. Although FIG. 3 illustrates the oil channel 9C at the curved side 9S3, embodiments of the present invention are not limited thereto. For example, the oil channel 9C may be at the first flat side 9S1. The rams 9 may further include a resistive device that applies an inward force to the moveable piece 9B that pulls it into the outer case 9A. In some embodiments, the resistive device may be one or more springs 9E inside the cavity 9D that are configured to oppose the movement of the moveable piece 9B out of the outer case 9A.

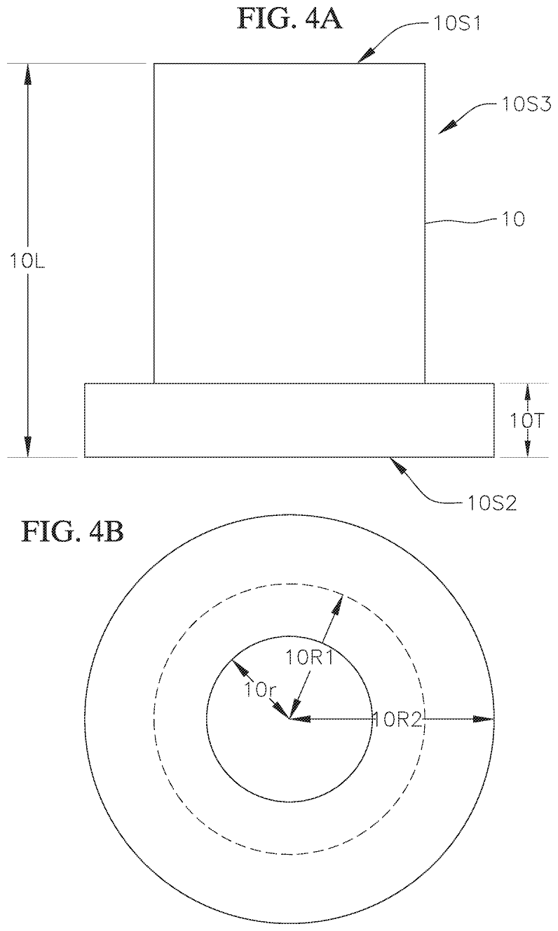

The collars 10 may have any suitable shape to allow them to be coupled to the rams 9 and to be inserted into the slots 8A of the lifting plates 8. With reference to FIGS. 4A and 4B, in some embodiments, the collars 10 may be generally cylindrical. In such embodiments, the collar 10 may have a first flat side 10S1, a second flat side 10S2, a curved outer side 10S3 having a length 10L between the two flat sides, and an inner side.

In some embodiments, a first outer radius 10R1 of the first flat side 10S1 may be different (e.g., smaller) than a second outer radius 10R2 of the second flat side 10S2. In such embodiments, the curved outer side 10S3 may have at least two different radii. For example, as illustrated in FIG. 4A, in some such embodiments, the curved outer side 10S3 may have a radius equal to the second outer radius 10R2 for a thickness 10T that extends from the second flat side 10S2 toward the first flat side 10S1, and a radius equal to the first outer radius 10R1 extending along the remainder of the length 10L of the collar 10. However, embodiments of the present disclosure are not limited thereto. For example, the radius of the curved outer side 10S3 may be equal to the second outer radius 10R2 at the second flat side 10S2, may be equal to the first outer radius 10R1 at the first flat side 10S1, and may gradually change (e.g., linearly or nonlinearly) along the length 10L of the curved outer side 10S3.

The inner side of the collar 10 may have a cylindrical shape. In such embodiments, the inner side may have an inner radius 10r. The inner side may have threading running along the length 10L of the inner side. In such embodiments, the threading may allow the collar to be coupled to the rams 9, and the inner radius 10r may be substantially equal to half of the diameter 9d of the rams 9. However, embodiments of the present disclosure are not limited thereto, and other means may be used to couple the collars 10 to the rams 9.

In some embodiments, the collars 10 may be coupled to the rams 9 so that the second flat side of the collar 10S2 is farther away from the first flat side of the ram 9S1 than is the first flat side of the collar 10S1. For example, the second flat side of the collar 10S2 may be aligned or substantially aligned with the second flat side of the ram 9S2, and the collar 10 may extend or run along part of the length of the ram 9 so that the first flat side of the collar 10S1 is closer to the first flat side of the ram 9S1 than is the second flat side of the collar 10S2.

The collar illustrated in FIGS. 4A and 4B may have any suitable dimensions. For example, the length 10L may be approximately 2 and 9/16 inches; the thickness 10T may be approximately 10/16 inches; the second outer radius 10R2 may be either approximately 2 and 9/16 inches or approximately 1 and 4.5/16 inches; the first outer radius 10R1 may be either approximately 2 inches or approximately 1 inch; and the inner radius 10r may be either approximately 1 and 10/16 inches or approximately 13/16 inches.

The collar 10 may be any suitable material. In some embodiments the collar 10 may include one or more metals or metal alloys. In some embodiments, the collar 10 may include steel. For example, the collar may include hot or cold rolled, mild steel, number 1018.

In some embodiments, the collars 10 may be omitted and the rams 9 may be fitted into the slots of the lifting plate 8 without the collars 10. In some embodiments, the rams 9 and corresponding collars 10 may form a single body. For example, in some embodiments, the rams 9 may include materials that may be included in the collars 10 and/or at least a portion of the ram 9 may have a shape similar to that of the collars 10, as described above.

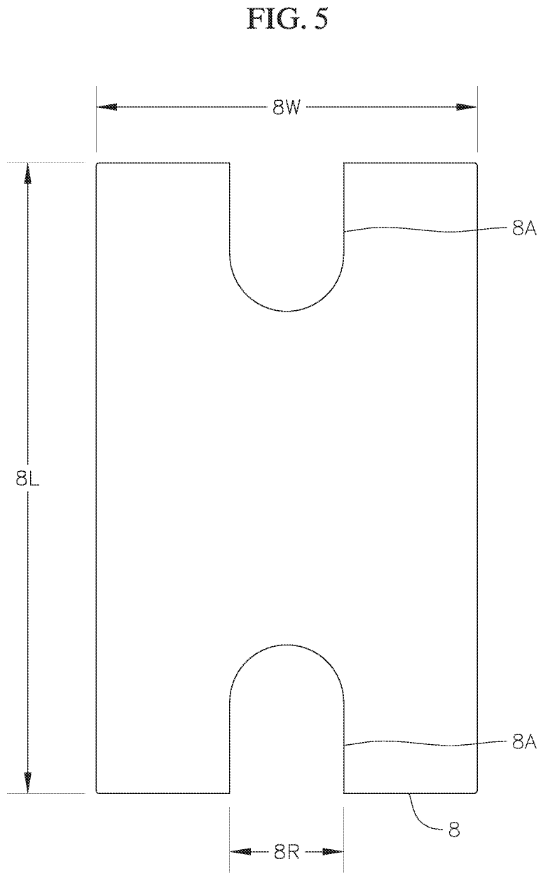

The lifting plate 8 may have any suitable shape. With reference to FIG. 5, the lifting plate 8 may be approximately rectangular. In such embodiments, the lifting plate 8 may have any suitable dimensions. For example, the lifting plate 8 may have a length 8L of about 26 inches, a width 8W of about 12 inches, and a thickness of either about 1 inch or about 1 and 10/16 inches.

The lifting plate 8 may have slots 8A penetrating through the thickness of the plate. The slots 8A may have any suitable shape to allow the collar 10 to be fitted into the slot 8A. For example, when the collar 10 is generally cylindrical, the slots 8A may be generally circular in shape and have a radius 8R that is equal or substantially equal to an outer radius of the collar (e.g., the first outer radius 10R1). Although the slots 8A of the lifting plates 8 in FIGS. 1 and 5 are illustrated as indents in the sides of the lifting plates 8, embodiments of the present disclosure are not limited thereto. For example, the slots 8A may be provided as holes in the lifting plates 8 through which the collars 10 may be inserted. In some embodiments, the lifting plate 8 may not have a polygonal shape. For example, the lifting plate 8 may have a circular shape with slots 10 at two sides (e.g., opposite sides, for example, left and right sides) of the lifting plate 8.

When the collar 10 illustrated in FIGS. 4A and 4B is fitted into the slots 8A, the lifting plate 8 may rest on top of the thicker portion of the curved outer side 10S3 of the two collars 10 such that the second flat side 10S2 is under the lifting plate 8 (e.g., the second flat side 10S2 may face, or rest on, the ground). In such an embodiment, when oil is pumped into the cavity 9D of the rams 9, the moveable piece 9B may be forced downward, causing the lifting plate 8 to move upward.

The lifting plate 8 may be any suitable material. In some embodiments, the lifting plate 8 may include one or more metals or metal alloys. In some embodiments, the lifting plate 8 may include steel. For example, the lifting plate 8 may include hot or cold plate, mild steel, number A36.

Although FIG. 1 illustrates the lifting device in assembled form, the lifting device may be disassembled for storage, transportation, or for other reasons. For example, the rams 9 and collars 10 may be removed from slots 8A of the lifting plates 8; the collars 10 may be decoupled from the rams 9, the four hoses 7 may be decoupled from the rams 9 and from the manifold 5; and the manifold 5 may be decoupled from the oil pump 3.

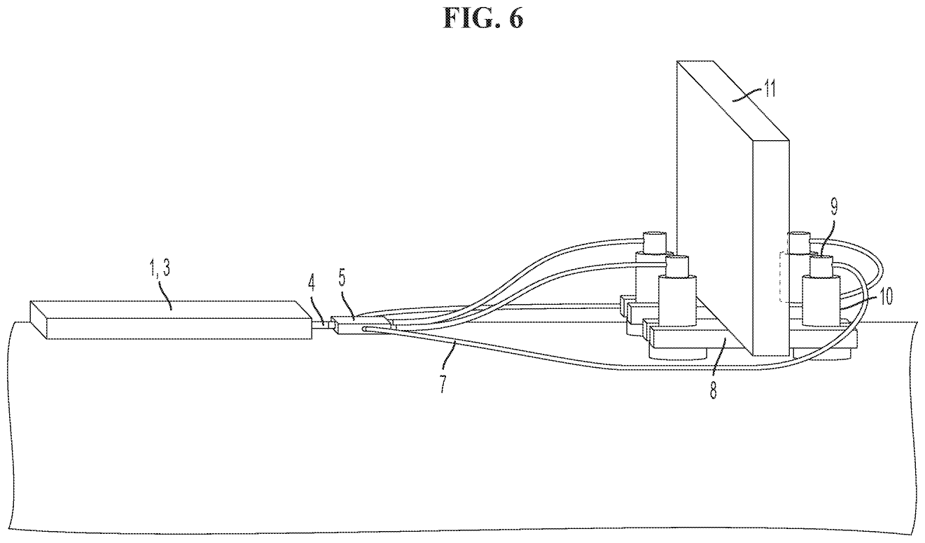

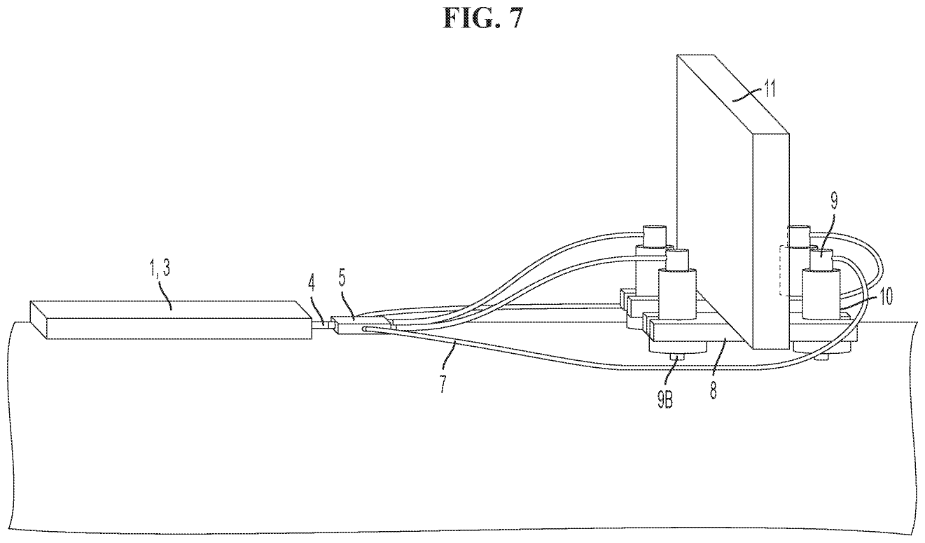

The lifting device may be used, for example, during construction of a building or structure to lift a wall panel off the ground. A description of the assembly and operation of the lifting device for such a use will now be provided with reference to FIGS. 6 and 7. FIGS. 6 and 7 illustrate the lifting device in a fully assembled state and during operation of the lifting device to lift a wall panel. FIG. 6 illustrates operation of the lifting device when the pump is turned off, and FIG. 7 illustrates operation of the lifting device when the pump is turned on. In FIGS. 6 and 7, the oil reservoir 1 and the oil pump 3 are integrated into a single body, and the first coupling device 2 is omitted. With reference to FIGS. 6 and 7, each of the two lifting plates 8 may be slid half-way under the wall panel 11 so that a bottom surface of the wall panel 11 extends across the center of each of the two lifting plates 8 and extends between the two slots 8A of each of the two lifting plates 8. The collars 10 may be coupled to their respective rams 9, and the rams 9 and collars 10 may be fitted into their respective slots 8A so that each of the two lifting plates 8 rest on top of a portion of the collars 10 that is thicker than a portion of the collars 10 at which the collars 10 are fitted into the slots 8A (see FIG. 4A). The rams 9 may be configured so that the movable piece 9B of the rams 9 will extend downward when activated by the oil pump 3. The manifold 5 may be coupled to the oil pump 3, and one end of each of the four hoses 7 may be coupled to the manifold 5, and the other end of each of the four hoses 7 may be coupled to a corresponding ram 9. If the oil pump 3 is on one side of the wall panel 11, then the other end of two of the hoses 7 may be passed under the wall panel 11 before being coupled to their corresponding rams 9. When the lifting device is fully assembled, the oil pump 3 may be activated, causing the movable piece 9B of the rams 9 to extend downward, thereby causing the rams 9 and collars 10 to be pushed upward. Because the lifting plates 8 rest on top of the thicker portion of the collars 10, the lifting plates 8 (and the wall panel 11) will be pushed upward, as illustrated in FIG. 7. Accordingly, the lifting device may be utilized to lift the wall panel 11.

According to embodiments of the present disclosure, a lifting device including four rams coupled to two lifting plates may be operated by a single pump to lift a heavier object than could be lifted by two rams and a single lifting plate. Because the four rams are operated by a single pump, the two lifting plates can be operated with increased safety compared to when each of the two lifting plates and their corresponding two rams are operated by separate pumps. Moreover, because the operability of a ram (e.g., the extent to which the moveable piece of the ram extends in response to a given pressure applied from the pump) may decline over time with use of the ram, when the pump operates all four rams substantially simultaneously, all four rams will tend to maintain substantially the same level of operability, and thus the lifting device may be used with increased safety and efficiency compared to when each of the two lifting plates and their corresponding two rams are operated by separate pumps.

While the subject matter of the present disclosure has been described in connection with the disclosed embodiments, it is to be understood that the subject matter of the present disclosure is not limited to the disclosed embodiments, but, on the contrary, the present disclosure is intended to cover various modifications and equivalent arrangements included within the spirit and scope of the appended claims, and equivalents thereof.

What is claimed is:

1. A lifting device comprising:
two lifting plates;
four rams coupled to the two lifting plates; and
a pump coupled to the four rams to operate the four rams,
wherein two of the four rams are coupled at two sides of one of the two lifting plates, and
wherein the other two of the four rams are coupled at two sides of another one of the two lifting plates.

2. The lifting device of claim 1, wherein the pump is configured to operate all four rams substantially simultaneously and substantially uniformly.

3. The lifting device of claim 1,
further comprising four hoses to couple the pump to the four rams, and
wherein the pump is a hydraulic pump configured to transfer a hydraulic fluid between the pump and the four rams through the four hoses.

4. The lifting device of claim 3, wherein the hydraulic pump is configured to transfer oil substantially simultaneously to the four rams.

5. The lifting device of claim 4 further comprising a manifold to couple the hydraulic pump to the four hoses,
wherein the manifold has an input port to allow the transfer of oil between the hydraulic pump and the manifold, and
wherein the manifold has four output ports to allow the transfer of oil between the manifold and the four hoses.

6. The lifting device of claim 5, wherein the manifold is configured to allow the transfer of oil substantially uniformly to the four rams.

7. The lifting device of claim 6,
wherein the manifold has at least four sides,
wherein the input port is on a first side of the four sides,
wherein a first output port and a second output port are on a second side of the four sides opposite to the first side,
wherein a third output port is on a third side of the four sides, and
wherein a fourth output port is on a fourth side of the four sides opposite to the third side.

8. The lifting device of claim 6,
wherein the manifold has at least five sides,
wherein the input port is on a first side of the five sides, and
wherein each of the four output ports is on a corresponding one of the remaining four sides of the five sides.

9. The lifting device of claim 6,
wherein the manifold has at least three sides,
wherein the input port is on a first side of the three sides,
wherein two of the four output ports are on a second side of the three sides, and
wherein the other two of the four output ports are on a third side of the three sides.

10. The lifting device of claim 6,
wherein the manifold has at least two sides,
wherein the input port is on a first side of the two sides, and
wherein the four output ports are on a second side of the two sides.

11. The lifting device of claim 6, wherein the manifold comprises a metal.

12. The lifting device of claim 3,
wherein each of the two lifting plates has two slots at two sides of the lifting plate penetrating through the thickness of the lifting plate, and
wherein the rams are fitted into the slots to be coupled to the lifting plates.

13. The lifting device of claim 12, further comprising four collars coupled to the four rams,
wherein the four collars are fitted into the slots to couple the four rams to the two lifting plates.

14. The lifting device of claim 13,
wherein one of the collars has an outer surface having a first portion and a second portion adjacent to the first portion along a length of the collar,
wherein the first portion has a first shape to allow the collar to be fitted into the corresponding slot at the first portion, and
wherein the second portion has a second shape to prevent the lifting plate of the corresponding slot from moving along the length of the collar in a direction from the first portion toward the second portion.

15. The lifting device of claim 14, wherein the second portion protrudes away from the first portion.

16. The lifting device of claim 15,
wherein the first portion has a first cylindrical shape having a first radius within the range of about 1 inch to about 2 inches, and
wherein the second portion has a second cylindrical shape having a second radius greater than the first radius and within the range of about 1.250 inches to about 2.625 inches.

17. The lifting device of claim 15, wherein the collar comprises steel.

18. The lifting device of claim 12, wherein one of the slots is an indentation in the corresponding side of the corresponding lifting plate.

19. The lifting device of claim 12, wherein one of the slots is a hole at the corresponding side of the corresponding lifting plate.

20. A lifting device comprising:
two lifting plates, each of the two lifting plates having two slots in opposite sides of the lifting plate, the slots being indentations penetrating through the thickness of the lifting plates;
four rams coupled to the four slots in the two lifting plates;
four collars attached to the four rams to couple the four rams to the four slots of the two lifting plates, the collars comprising steel;
a hydraulic pump coupled to the four rams and configured to transfer oil between the hydraulic pump and the four rams;
a manifold coupled between the hydraulic pump and the four rams, the manifold comprising a metal;
four hoses, each hose having one end coupled to the manifold and another end coupled to a corresponding one of the four rams;
wherein the hydraulic pump is configured to transfer oil substantially simultaneously to the four rams,
wherein the manifold has an input port configured to allow the transfer of oil between the hydraulic pump and the manifold, and four output ports configured to allow the transfer of oil substantially uniformly between the manifold and the four hoses,
wherein the input port and two of the four output ports are at two opposite sides of the manifold and the other two of the four output ports are at another two opposite sides of the manifold,
wherein an outer surface of each of the four collars has a first portion at which the collars are coupled to the corresponding slot, and a protruding portion that protrudes away from the first portion to prevent the lifting plate of the corresponding slot from moving along a length of the collar in a direction from the first portion toward the protruding portion.
